(19) United States
(12) Patent Application Publication
(10) Pub. No.: US 2012/0132583 A1
(43) Pub. Date: May 31, 2012

(54) FLUORINE-BASED HOLLOW-FIBER MEMBRANE AND A PRODUCTION METHOD THEREFOR

(75) Inventors: Jihyang Son, Yuseong-gu (KR); Younglim Koo, Yuseong-gu (KR); Jonghun Lee, Seongnam-si (KR); Junghoon Choi, Yuseong-gu (KR); Sungyong Kang, Anyang-si (KR); Yongjoo Yi, Goyang-si (KR)

(73) Assignee: LG HAUSYS, LTD., Seoul (KR)

(21) Appl. No.: 13/389,386

(22) PCT Filed: Sep. 15, 2010
(86) PCT No.: PCT/KR2010/006319

§ 371 Date: Feb. 7, 2012

(30) Foreign Application Priority Data
Sep. 25, 2009 (KR) 10-2009-0091325

(51) Int. Cl. B01D 69/04; D01F 1/08; D04H 13/00

(52) U.S. Cl. 210/500.23; 428/292.1; 264/171.26

(57) ABSTRACT

The present invention relates to a fluorine-based hollow-fiber membrane and to a production method therefor. The present invention provides: a fluorine-based hollow-fiber membrane which exhibits a sponge-like pore structure even though it has an asymmetrical structure; and a production method therefor. Consequently, the present invention can provide: a fluorine-based hollow-fiber membrane with an outstanding filtering performance and backwash performance despite also having excellent mechanical strength; and a production method therefor.

### CROSS-REFERENCE TO RELATED APPLICATIONS

This application is based upon and claims the benefit of priority from Korean Patent Applications No. 2009-091325, filed on Sep. 25, 2009, the entire content of which is incorporated herein by reference.

### TECHNICAL FIELD

The present disclosure relates to a fluorine-based hollow-fiber membrane and a production method therefor.

### BACKGROUND

In order to separate materials effectively, various separation processes such as distillation, extraction, absorption, adsorption or recrystallization have been traditionally used. However, the said traditional separation processes have difficulties such as large energy consumption and inefficiency of space use.

In line with this, the importance of a separation membrane as an energy saving separation process is growing so as to replace the said conventional separation processes. The separation membrane is identified as a selective barrier existing between two phases. Particularly, the industrial demand of a polymer separation membrane having functions such as selective separation and efficient material permeation is being continually expanded to the chemical, environmental, medical, bio and food industries.

Further, the importance of the polymer separation membrane increases further due to the growing seriousness of environmental pollution such as industrial and agricultural waste water, the supply of drinking water, or treatment of toxic industrial waste throughout the world.

For example, a fluorine-based hollow-fiber membrane (ex. PVDF(polyvinylidene fluoride)-based hollow-fiber membrane) as one of representative polymer separation membranes is being noted as a separation membrane for ultrafiltration(UF) or microfiltration(MF). There is non-solvent phase separation as a representative method to prepare the fluorine-based hollow-fiber membrane. The non-solvent phase separation is a method to induce non-solvent organic phase separation and form a porous structure by extruding a copolymer solution dissolved in an appropriate solvent through a double pipe type nozzle at a temperature lower than the melting point of the resin followed by contacting with a liquid comprising the non-solvent of the resin.

The hollow-fiber membrane prepared as described above has advantages that it is more economic than a thermally-induced phase separation, and has good backwash and fouling-removing effects. However, the hollow-fiber membrane prepared by the non-solvent phase separation has low mechanical strength because the pore formation on the membrane surface is difficult and an asymmetric structural membrane having macrovoids is usually formed.

### SUMMARY

The present disclosure provides a fluorine-based hollow-fiber membrane and a production method therefor.

According to one embodiment of the present disclosure, provided is a fluorine-based hollow-fiber membrane which comprises: a filter region which has a sponge-like structure and contains pores having an average diameter of 0.01 μm to 0.5 μm; a support region which has a sponge-like structure and contains pores having an average diameter of 0.5 μm to 5 μm; and a backwash region which has a sponge-like structure and contains pores having an average diameter of 2 μm to 10 μm, wherein the filter region, support region and backwash region are sequentially formed in the direction from the outer surface to the inner surface of the membrane.

According to another embodiment of the present disclosure, provided is a production method for the hollow-fiber membrane, which comprises the following steps of:

1) by using a double pipe type nozzle which has an inner pipe and outer pipe, wherein a ratio (L/D) of the nozzle length (L) to the width of the outer pipe (D) is more than 3, discharging an internal bore fluid through the inner pipe of the nozzle; and discharging a spinning solution to the outer pipe of the nozzle; and

2) contacting the spinning solution with an external bore fluid.

According to another embodiment of the present disclosure, provided is a fluorine-based hollow-fiber membrane, which is produced by the method of the present invention, and has the tensile breaking strength of more than 4 MPa.

### BRIEF DESCRIPTION OF THE DRAWINGS

FIG. 1 is a diagram of the pore structure of the hollow-fiber membrane of the present invention.

FIG. 2 is a drawing representing an example of the double pipe type nozzle which can be used in the present invention.

FIG. 3 is a schematic drawing representing a procedure for preparing the hollow-fiber membrane of the present invention.

FIGS. 4 to 7 are scanning electron microscopy (SEM) images of the hollow-fiber membranes prepared in Examples and Comparative Examples of the present invention.

### DETAILED DESCRIPTION

The present invention relates to a fluorine-based hollow-fiber membrane which comprises: a filter region which has a sponge-like structure and contains pores having an average diameter of 0.01 μm to 0.5 μm; a support region which has a sponge-like structure and contains pores having an average diameter of 0.5 μm to 5 μm; and a backwash region which has a sponge-like structure and contains pores having an average diameter of 2 μm to 10 μm, wherein the filter region, support region and backwash region are sequentially formed in the direction from the outer surface to the inner surface of the membrane.

Hereinafter, the fluorine-based hollow-fiber membrane of the present invention will be described in detail.

The hollow-fiber membrane of the present invention which has a sponge-like pore structure while it has an asymmetrical structure wherein the pore size increases sequentially in the direction from the outer surface to the inner surface. The term [symbol] sponge-like structure [symbol] used herein refers to there being no macrovoids, specifically, macro-pores having an average diameter of more than tens of μm in the pore structure.

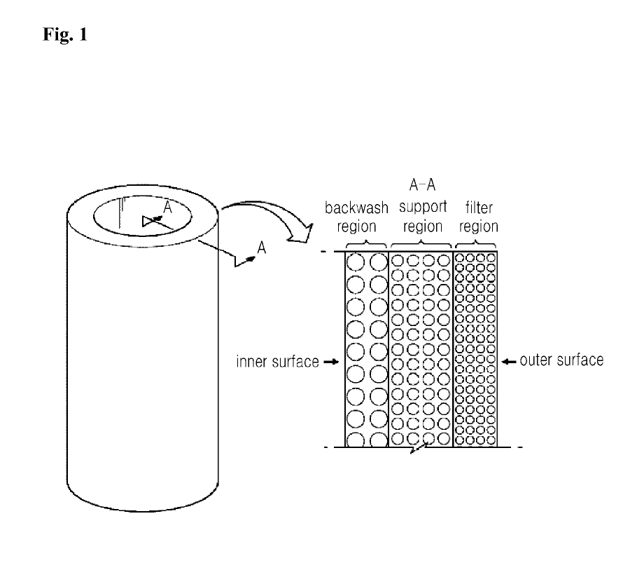

The hollow-fiber membrane of the present invention contains the filter region, support region and backwash region which are sequentially formed in the direction from the outer surface to the inner surface of the membrane, and the regions have a sponge-like structure, respectively. As shown in FIG. 1, the term [symbol] filter region [symbol] used herein refers to a region formed adjacent to the outer surface of the hollow-fiber membrane and having a sponge-like structure which contains pores having an average diameter of about 0.01 to 0.5 μm, preferably about 0.05 μm to 0.3 μm, and more preferably about 0.2 μm. Further, as shown in FIG. 1, the term [symbol] support region [symbol] used herein refers to a region formed in the middle of the hollow-fiber membrane and having a sponge-like structure which contains pores having an average diameter of about 0.5 to 5 μm, preferably about 0.5 μm to 2 μm, and more preferably about 1 μm. As shown in FIG. 1, the term [symbol] backwash region [symbol] refers to a region formed adjacent to the inner surface of the hollow-fiber membrane and having a sponge-like structure which contains pores having an average diameter of about 2 to 10 μm, preferably about 2 μm to 5 μm, and more preferably about 2 μm. For example, in the present invention, the average diameters of the pores contained in the filter, support and backwash regions increase in that order. Further, as shown in FIG. 1, the filter, support and backwash regions can be formed successively in the direction of the outer surface of the hollow-fiber membrane to the inner surface.

In the present invention, the average diameter of the internal pore of the hollow-fiber membrane can be measured by embodying the cross section of the hollow-fiber membrane using SEM, for example, followed by measuring the pore size distribution.

In the present invention, the ratio of the filter, support and backwash regions formed inside of the hollow-fiber membrane is not particularly limited. For example, in the present invention, the ratio (Lₛ/L_{f}) of the cross section length of the support region (Lₛ) to the cross section length of the filter region (L_{f}) may be about 10 to 70, preferably 20 to 60. The ratio (L_{b}/L_{f}) of the cross section length of the backwash region (L_{b}) to the cross section length of the filter region (L_{f}) may be in the range from about 5 to 30, preferably from 5 to 20. Further, in the present invention, the summation (L_{f}+Lₛ+L_{b}) of the length of the filter, support and backwash regions may be in the range from about 100 μm to 400 μm, and preferably from about 200 μm to 300 μm.

In addition, the average diameter of the pores formed in the outer surface of the inventive hollow-fiber membrane may be in the range from about 0.01 μl to 0.05 μm, and the average diameter of the pores formed in the inner surface may be in the range from about 2 μm to 10 μm.

In the present invention, the pore patterns and structure can be controlled as described above to produce a hollow-fiber membrane, which shows good mechanical strength as well as excellent backwash ability, filterability and water permeability.

Namely, the hollow-fiber membrane of the present invention may have a tensile breaking strength of more than about 4 MPa, preferably more than 4.5 MPa, and more preferably more than about 5 MPa. The above tensile strength of the present invention may be measured, for example, by the tensile test using the tensile tester (Zwick Z100). Specifically, the tensile strength can be measured under the condition of a temperature of about 25° C. and relative humidity of about 40% to 70% by fixing the wet hollow-fiber membrane to the tensile tester (distance between chuck: about 5 cm), elongating the membrane at the rate of about 200 mm/min, and measuring the weight thereof at the point when the test piece (hollow-fiber membrane) is fractured. In the present invention, if the tensile breaking strength is less than 4 MPa, the mechanical strength of the hollow-fiber membrane decreases so that stable operation for a long period of time may be difficult. On the other hand, the hollow-fiber membrane of the present invention has better mechanical strength as the tensile breaking strength thereof is larger, but the upper maximum is not limited thereto and, for example, the tensile breaking strength can be controlled to be no more than 12 MPa.

Further, the inventive hollow-fiber membrane may have a tensile breaking elongation of more than about 60%, preferably more than 80%, more preferably more than 100%, and most preferably more than 150%. In the present invention, the tensile breaking elongation can be measured, for example, by a method similar to that used to measure the tensile breaking strength. Namely, the tensile breaking elongation can be measured under the same temperature and humidity conditions used to measure the tensile breaking strength by fixing the wet hollow-fiber membrane to the tensile tester (distance between chuck: about 5 cm), elongating the membrane at the rate of about 200 mm/min, and measuring the shift at the point when the test piece (hollow-fiber membrane) is fractured. In the present invention, if the tensile breaking elongation is less than 60%, the mechanical strength of the hollow-fiber membrane decreases so that stable operation for a long period of time may be difficult. In addition, the hollow-fiber membrane of the present invention has better mechanical strength as the tensile breaking elongation thereof gets bigger, but the upper maximum is not limited thereto and, for example, the tensile breaking elongation can be controlled to be no more than 200%.

Further, the pure water permeability (flux) of the inventive hollow-fiber membrane may be more than 60 LMH(L/m²·hr), preferably more than 80 LMH(L/m²·hr), more preferably more than about 100 LMH(L/m²·hr). For example, in the present invention, the pure water permeability can be measured by the method disclosed in Examples. If the pure water permeability is less than 60 LMH(L/m²·hr) in the present invention, the water treatment efficiency of the hollow-fiber membrane may decrease. On the other hand, the hollow-fiber membrane of the present invention has better water treatment performance as the pure water permeability thereof is higher, but the upper maximum is not limited thereto and, for example, the pure water permeability can be controlled to be no more than 450 LMH(L/m²·hr).

While the hollow-fiber membrane of the present invention shows the said pore characteristics, tensile breaking strength, tensile breaking elongation or permeability, the specific material type thereof is not particularly limited. The example of the fluorine-based hollow-fiber membrane of the present invention may include polytetrafluoroethylene(PTFE)-based hollow-fiber membrane, tetrafluoroethylene-perfluoroalkyl vinyl ether copolymer(PFA)-based hollow-fiber membrane, tetrafluoroethylene-hexafluoropropylene copolymer(FEP)-based hollow-fiber membrane, tetrafluoroethylene-hexafluoropropylene-perfluoroalkyl vinyl ether copolymer(EPE)-based hollow-fiber membrane, tetrafluoroethylene-ethylene copolymer(ETFE)-based hollow-fiber membrane, polychlorotrifluoroethylene(PCTFE)-based hollow-fiber membrane, chlorotrifluoroethylene-ethylene copolymer(ECTFE)-based hollow-fiber membrane or polyvinylidene fluoride(PVDF)-based hollow-fiber membrane. The tetrafluoroethylene-ethylene copolymer, polychlorotrifluoroethylene and polyvinylidene fluoride, preferably polyvinylidene fluoride-based hollow-fiber membrane can be used in that it has good ozone resistance and mechanical strength, but is not limited thereto. Example of the material included in the polyvinylidene fluoride-based hollow-fiber membrane may be a homopolymer of vinylidene fluoride, or copolymer of vinylidene fluoride and other monomer which can be copolymerized therewith. A specific example of the monomer which can be copolymerized with the vinylidene fluoride may include one or more selected from tetrafluoroethylene, hexafluoropropylene, trifluoroethylene, trifluoro-chloroethylene and fluorovinyl, but not limited thereto.

The method to prepare the hollow-fiber membrane in the present invention which meets the said properties is not particularly limited, and the hollow-fiber membrane can be prepared by applying techniques well known in the related art.

Particularly, in order to efficiently prepare the fluorine-based water treatment membrane which meets the said properties in the present invention, the fluorine-based hollow-fiber membrane can be produced by a method which comprises the following steps of:

1) by using a double pipe type nozzle which has an inner pipe and outer pipe, wherein a ratio (L/D) of the nozzle length (L) to the width of the outer pipe (D) is more than 3, discharging an internal bore fluid through the inner pipe of the double pipe type nozzle; and discharging a spinning solution to the outer pipe of the nozzle; and

2) contacting the spinning solution with an external bore fluid.

In the method of the present invention, the hollow-fiber membrane having the desired properties can be prepared by controlling the form of the double pipe type nozzle used to discharge the spinning solution in the procedure to prepare the hollow-fiber membrane by the non-solvent phase separation.

Specifically, the present invention may use the double pipe type nozzle to discharge the spinning solution, wherein the ratio (L/D) of the nozzle length (L) to the width of the outer pipe (D) included in the nozzle is more than 3, preferably more than 5, and more preferably more than 7.

In the present invention, if the ratio is less than 3, the effect of the molecular rearrangement may not be fully exhibited so that macrovoids can occur, and the sponge-like pore structure cannot be exhibited efficiently. Further, the induction efficiency of the molecular rearrangement improves and macrovoid (macropore) formation can be inhibited as the ratio (L/D) of the present invention has a better value, but the value is not particularly limited. For example, in the present invention, the ratio (L/D) can be controlled within the range of below 10, preferably below 8 in consideration of the possibility of the nozzle damage.

The specific configuration of the double pipe type nozzle which can be used in the present invention is not particularly limited while it is within a standard of the said range.

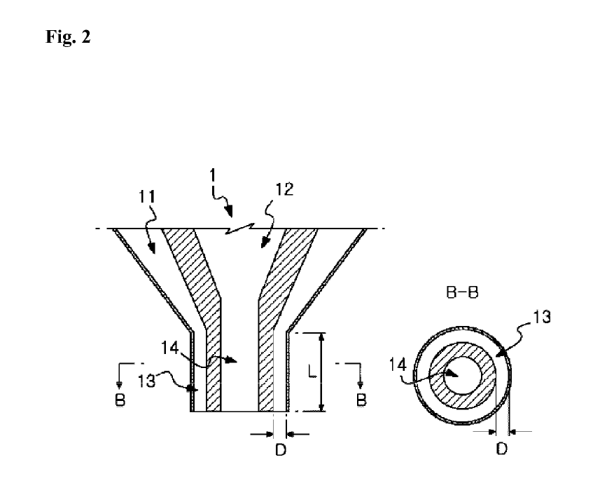

For example, as shown in the attached FIG. 2, the double pipe type nozzle (1) which comprises a spinning solution inlet (11) where the spinning solution is provided; outer pipe (13) where the spinning solution is discharged to the exterior, internal bore fluid inlet (12) where the internal bore fluid is provided; and inner pipe (14) where the internal bore fluid is discharged to the interior can be used in the present invention.

On the other hand, the term [symbol] nozzle length [symbol] used in the present invention refers to the length of the said inner or outer pipe, for example, the length marked as L in the attached FIG. 2.

Further, the term [symbol] outer pipe width [symbol] used in the present invention refers to a width of the outer pipe which is included in the double pipe type nozzle and used as a flow path of the spinning solution, and for example, the length marked as D in the attached FIG. 2.

In the present invention, while the ratio of the nozzle length (L) and the outer pipe width (D) meets the said range, each specific dimension is not particularly limited. For example, the nozzle length (L) can be set within the range of 0.5 mm to 5 mm in the present invention.

In step 1) of the production method of the present invention, the spinning solution and internal bore fluid are discharged simultaneously or sequentially, respectively using the double pipe type nozzle as described above.

At this time, the composition of the spinning solution is not particularly limited and can be selected properly in consideration of the desired hollow-fiber membrane. In the present invention, for example, the spinning solution may contain a fluorine-based polymer and appropriate solvent for the polymer.

In the present invention, the kind of the fluorine-based polymer contained in the spinning solution is not particularly limited, and the conventional fluorine-based polymer can be used in consideration of the desired hollow-fiber membrane. In the present invention, for example, polytetrafluoroethylene(PTFE)-based polymer, tetrafluoroethylene-perfluoroalkyl vinyl ether copolymer(PFA)-based polymer, tetrafluoroethylene-hexafluoropropylene copolymer(FEP)-based polymer, tetrafluoroethylene-hexafluoropropylene-perfluoroalkyl vinyl ether copolymer(EPE)-based polymer, tetrafluoroethylene-ethylene copolymer(ETFE)-based polymer, polychlorotrifluoroethylene(PCTFE)-based polymer, chlorotrifluoroethylene-ethylene copolymer(ECTFE)-based polymer or polyvinylidene fluoride(PVDF)-based polymer can be used, and tetrafluoroethylene-ethylene copolymer, polychlorotrifluoroethylene and polyvinylidene fluoride, preferably, the polyvinylidene fluoride-based polymer can be used in that it has good ozone resistance and mechanical strength, but is not limited thereto. Examples of the polyvinylidene fluoride-based polymer may include a homopolymer of vinylidene fluoride, or copolymer of vinylidene fluoride and other monomer which can be copolymerized therewith. Specific examples of the monomer which can be copolymerized with the vinylidene fluoride may include one or more selected from tetrafluoroethylene, hexafluoropropylene, trifluoroethylene, trifluoro-chloroethylene and fluorovinyl, but not limited thereto.

In the present invention, the fluorine-based polymer contained in the spinning solution may have the weight average molecular weight in the range from 100,000 to 1,000,000, and preferably from 200,000 to 500,000. If the weight average molecular weight of the inventive fluorine-based polymer is less than 100,000, the mechanical strength of the hollow-fiber membrane may decrease, and if it exceeds 1,000,000, the porous efficiency may go down by the phase separation.

In the present invention, the spinning solution may include a good solvent with the fluorine-based polymer described above. The term [symbol] good solvent [symbol] used in the present invention refers to a solvent which can dissolve the fluorine-based polymer at the temperature below the melting point of the fluorine-based resin, specifically about 20° C. to 180° C. Specific examples of the appropriate solvent which can be used in the present invention may not be limited as long as they have the above characteristics. For example, it may be one or more selected from the group consisting of N-methylpyrrolidone, dimethylformamide, dimethylacetamide, dimethylsulfoxide, methylethylketone, acetone and tetrahydrofuran. It is preferred that the appropriate solvent in the present invention may be N-methylpyrrolidone, but not limited thereto.

In the spinning solution of the present invention, the appropriate solvent may be used in the amount of 150 weight parts to 900 weight parts, preferably 300 weight parts to 700 weight parts based on the 100 weight parts of the fluorine-based polymer described above. If the amount of the appropriate solvent in the present invention is less than 150 weight parts, the porous efficiency may decrease due to phase separation, and if it exceeds 900 weight parts, the mechanical strength of the hollow-fiber membrane may go down.

Further, the spinning solution of the present invention may contain various conventional additives which are well known in the art in addition to the fluorine-based polymer and the appropriate solvent. Namely, there are various well known additives in this art in order to improve the porous efficiency of the hollow-fiber membrane and to control the viscosity of the spinning solution, and one or more additives can be selected properly and used in the present invention according to their purpose. The kind of the additives which can be used in the present invention may be polyethyleneglycol, glycerin, diethylglycol, triethylglycol, polyvinylpyrrolidone, polyvinylalcohol, ethanol, water, lithium perchlorate or lithium chloride, but not limited thereto.

The preparing method of the spinning solution comprising the above components in the present invention is not particularly limited. In the present invention, the spinning solution can be prepared, for example, by mixing the above components under proper conditions followed by aging and removing gas contained in the solution. At this time, the mixing process of the each component can be conducted, for example, at the temperature of about 60° C. Further, the degassing process can be conducted, for example, by purging nitrogen (N₂) gas at the temperature of about 60° C. for about 12 hours, but not limited thereto.

In the present invention, the kind of the internal bore fluid which is discharged through the inner pipe of the double pipe type nozzle with the above spinning solution is not particularly limited. In the present invention, examples of the internal bore fluid may be water (ex. pure water or tap water) or a mixture of water and an organic solvent. A specific example of the organic solvent may be one or more selected from N-methylpyrrolidone, dimethylformamide, dimethylacetamide, dimethylsulfoxide, methylethylketone, acetone, tetrahydrofuran and polyhydric alcohol. Further, the polyhydric alcohol may be an alcohol having 2 to 9 hydroxy groups, specifically an alkyleneglycol having 1 to 8 carbon atoms such as ethyleneglycol or propyleneglycol, or glycerol, but not limited thereto.

Particularly, in view of efficient control of the pore structure, the present invention may preferably use the mixture of water and organic solvent as the internal bore fluid, the mixture of water (ex. pure water) and more preferably N-methylpyrrolidine. At this time, the concentration of the organic solvent may be 10 weight % to 90 weight %, preferably 20 weight % to 80 weight %. If the concentration of the organic solvent in the present invention is less than 10 weight %, the expression efficiency of the sponge-like structure of the hollow-fiber membrane may decrease so that the mechanical strength may be diminished, and if it exceeds 90 weight %, the pore formation efficiency may go down

On the other hand, the temperature of the internal bore fluid described above in the present invention may be room temperature, specifically about 10° C. to 30° C. The term [symbol] room temperature [symbol] used in the present invention refers to the natural temperature range, not warmed or cooled temperature, specifically, as described above, a temperature of 10° C. to 30° C., preferably about 15° C. to 30° C., more preferably about 20° C. to 30° C., and most preferably about 25° C. If the temperature of the internal bore fluid in the present invention is too low, bubbles can be formed by reduction of the saturated water vapor pressure, or the discharging of the spinning solution may break. On the other hand, if the temperature is too high, the production efficiency may decrease because the spinning solution is dissolved before phase separation occurs.

In the present invention, the method to prepare the internal bore fluid described above is not particularly limited, and like the preparation of the above spinning solution, the internal bore fluid can be prepared by mixing each component under proper conditions and conducting the degassing process properly.

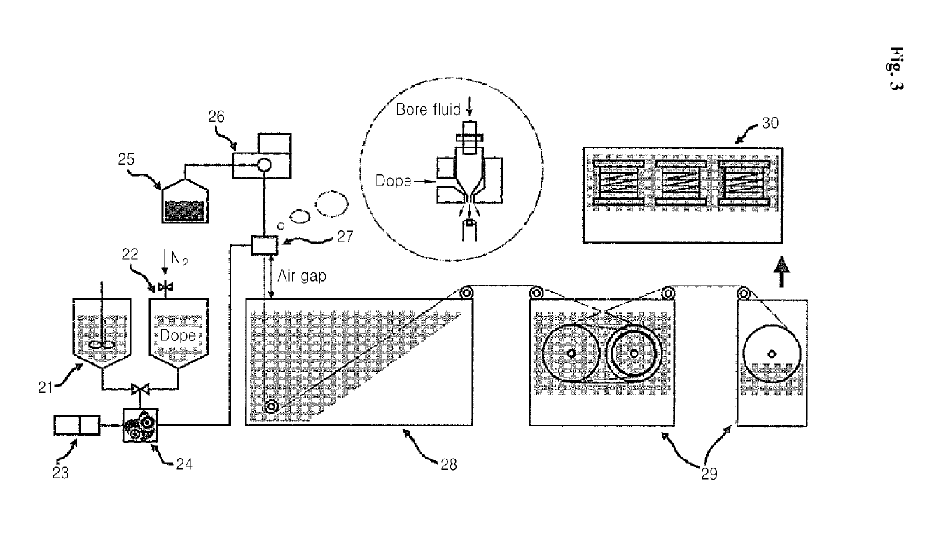

In step 1) of the present invention, the above spinning solution and the internal bore fluid is discharged through the outer and inner pipes, respectively, using the double pipe type nozzle. Referring to FIG. 3, the above procedure will be described as follows.

FIG. 3 attached herein is a drawing representing an example of the procedure for preparing the hollow-fiber membrane of the present invention. Namely, in the present invention, the spinning solution can be prepared, for example, by mixing each component of the spinning solution in a suitable mixer (21) followed by transferring to a tank (22), and then conducting the degassing process. Then, the prepared spinning solution can be transferred to the double pipe type nozzle (27) using a pump (24) equipped with a motor (23), and discharged through the outer pipe. Further, simultaneously or sequentially, the internal bore fluid stored in an internal bore fluid tank (25) also can be transferred to the double pipe type nozzle (27) using suitable means such as a pump (26), and discharged through the inner pipe.

The condition to discharge (spin) the spinning solution and internal bore fluid (ex. Discharging rate or temperature) is not particularly limited. In the present invention, for example, the discharging can be conducted at the rate of about 6 cc/min to 20 cc/min, preferably 8 cc/min to 15 cc/min. Further, the discharging process can be conducted at the temperature range from about 15° C. to 100° C., preferably about 25° C. to 60° C. However, the discharging rate and temperature are only one embodiment of the present invention. Namely, in the present invention, the discharging rate and temperature may be selected properly in the consideration of the composition of the used spinning solution and/or internal bore fluid, or the physical properties of the desired hollow-fiber membrane.

In step 2) of the present invention, the discharged spinning solution described above using the double pipe type nozzle contacts with the external bore fluid. This process can be conducted, for example, by injecting the discharged spinning solution through the double pipe type nozzle (27) to a tank (28) storing the external bore fluid as shown in FIG. 3.

In the present invention, particularly at the above step, it is preferred that the discharged spinning solution from the double pipe type nozzle is controlled to contact with the external bore fluid as soon as the spinning solution is discharged. In the above description, contacting the discharged spinning solution with the external bore fluid may refer, for example, to wherein the discharging of the spinning solution is coincident with entering the solution to the external bore fluid by controlling the distance of the stored external bore fluids between the double pipe type nozzle (27) and tank (28) as shown in FIG. 3 so as not to form an air gap (i.e., air gap length is 0).

Thus, the hollow-fiber membrane having good mechanical strength and elongation properties can be prepared by contacting the spinning solution with the external bore fluid as soon as the spinning solution is discharged from the double pipe type nozzle.

On the other hand, the kind of the external bore fluid which can be used in the present invention is not particularly limited, and a conventional external bore fluid used in the non-solvent phase separation may be used. Particularly, the present invention may use a non-solvent with respect to the fluorine-based resin or a mixture of the non-solvent and appropriate solvent as the said external bore fluid. The term [symbol] non-solvent [symbol] used in the present invention refers to a solvent which does not actually dissolve the fluorine-based polymer at the temperature of below the melting point of the resin, specifically at about 20° C. to 180° C. The non-solvent which can be used in the present invention may be one or more selected from the group consisting of glycerol, ethyleneglycol, propyleneglycol, low molecular weight polyethyleneglycol and water (ex. pure water or tap water). In the present invention, water (ex. tap water) can be preferably used.

On the other hand, the kind of the appropriate solvent which can be used for the above mixed solution is not particularly limited. Specifically, it can be the organic solvent described in the above description regarding the internal bore fluid, preferably N-methylpyrrolidone.

If the present invention uses the said mixed solution as the external bore fluid, the concentration of the appropriate solvent included in the solution may be 0.5 weight % to 30 weight %, preferably 1 weight % to 10 weight %. If the concentration of the appropriate solvent in the mixed solution of the present invention is less than 0.5 weight %, the external pore formation efficiency may go down, and if it exceeds 30 weight %, macropores can be generated on the outer surface of the hollow-fiber membrane so that the filter efficiency may decrease.

In the present invention, the temperature of the said external bore fluid may be 40° C. to 80° C., preferably 40° C. to 60° C. If the temperature of the external bore fluid of present invention is less than 40° C., the mechanical strength and elongation of the hollow-fiber membrane may decrease by the formation of a spherical crystal structure, and if it exceeds 80° C., processing problems may occur by the evaporation of the non-solvent component.

In the present invention, the desired hollow-fiber membrane can be produced by inducing phase separation caused by contacting the discharged spinning solution from the double pipe type nozzle with the external bore fluid. Further, in the present invention, conventional after-treatment such as washing in a washing device (29) and rolling in a rolling device (30) can be conducted successively after the said contacting step with the external bore fluid.

According to the method of the present invention described above, the hollow-fiber membrane having the characteristic pore structure described above as well as the said mechanical strength (tensile breaking strength and elongation) and water permeability can be prepared effectively.

### EXAMPLE

Hereinafter, the following examples are provided to further illustrate the invention, but they should not be considered as the limit of the invention.

### Example 1

Polyvinylidene fluoride 15 weight parts, LiCl 5 weight parts and H₂O 3 weight parts were dissolved uniformly in N-methylpyrrolidone (NMP) 77 weight parts to prepare a spinning solution, and a hollow-fiber membrane was produced using a hollow-fiber membrane producing apparatus as shown in FIGS. 2 and 3. At this time, a ratio (L/D) of the length (L) to the width (D) of the outer pipe of the used double pipe type nozzle was 7, and the nozzle length (L) was 2.1 mm. Further, it was controlled as there was no distance between the double pipe type nozzle and the external bore fluid (namely, the air gap was 0 cm) to contact the discharged spinning solution with the external bore fluid as soon as the solution was discharged. A mixture of N-methylpyrrolidone (NMP) and water (NMP concentration: 80 wt %, room temperature) was used as an internal bore fluid, and water (60° C.) was used as the external bore fluid. In this Example, the discharging rate and temperature were adjusted to about 12 cc/min and room temperature, respectively when the spinning solution was discharged through the double pipe type nozzle.

### Example 2

The procedure of Example 1 was repeated except for using a mixture of NMP and water (NMP concentration: 20 wt %, room temperature) as the internal bore fluid to prepare the hollow-fiber membrane.

### Example 3

The procedure of Example 1 was repeated except for using a mixture of NMP and water (NMP concentration: 5 wt %, 60° C.) as the external bore fluid to prepare the hollow-fiber membrane.

### Comparative Example 1

The procedure of Example 1 was repeated except for using a double pipe type nozzle wherein the ratio (L/D) of the nozzle length (L) to the width (D) of the outer pipe was 2 and the nozzle length (L) was 0.7 mm to prepare the hollow-fiber membrane.

Preparation condition of above Examples and Comparative Example to prepare the hollow-fiber membranes were listed in Table 1.

TABLE 1

| | Example | | | Comp. |
|---|---|---|---|---|
| | 1 | 2 | 3 | Example 1 |
| L/D | 7 | 7 | 7 | 2 |
| L | 2.1 mm | 2.1 mm | 2.1 mm | 0.7 mm |
| Air gap | 0 cm | 0 cm | 0 cm | 0 cm |
| Internal | 80% NMP | 20% NMP | 20% NMP | 80% NMP |
| bore fluid | (room temp.) | (room temp.) | (room temp.) | (room temp.) |
| External | water (60° C.) | water | 5% NMP | water (room |
| bore fluid | | (60° C.) | (60° C.) | temp.) |

L/D: ratio of the double pipe type nozzle length (L) to the width of the outer pipe (D)
L: double pipe type nozzle length
Spinning solution composition: 15% PVDF/5% LiCl/3% H₂O/NMP
PVDF: poly(vinylidene fluoride)
NMP: N-methylpyrrolidone

### Test Example 1

### Pore Structure Analysis

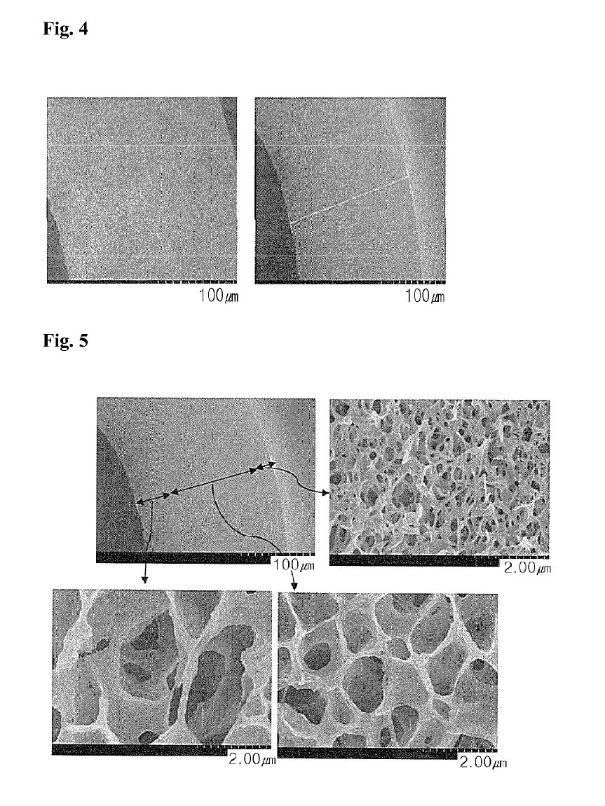

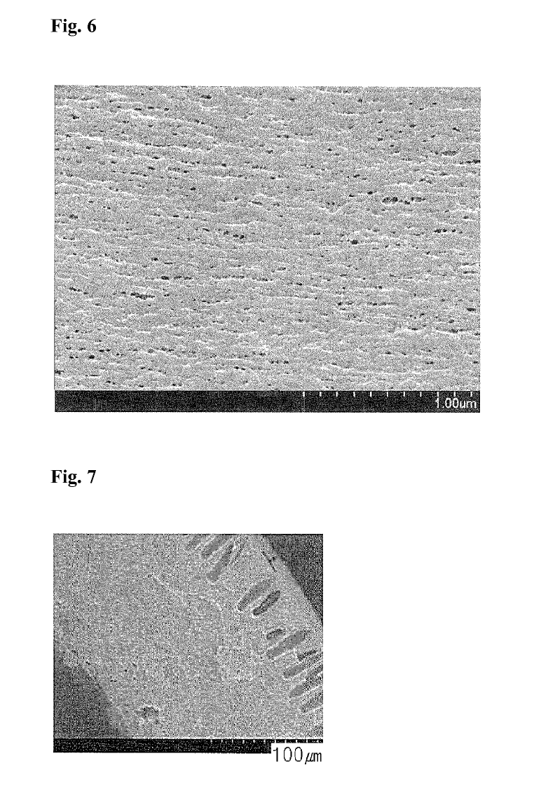

The images of the cross sections and outer surfaces of the hollow-fiber membranes prepared in Examples and Comparative Example were took using a Scanning Electron Microscope (SEM), and the results were shown in FIGS. 4 to 7. Specifically, FIG. 4 is a cross section image of the hollow-fiber membrane of Example 1, FIG. 5 is a pore structure image of the of the filter, support and backwash regions sequentially formed in the direction from the outer surface of the hollow-fiber membrane of Example 1, FIG. 6 is a outer surface image of the hollow-fiber membrane of Example 2, and FIG. 7 is a cross section image of the hollow-fiber membrane of Comparative Example 1, respectively. As confirmed from the attached FIGs, the hollow-fiber membranes of the present invention of Examples 1 and 2 exhibited sponge-like pores without macrovoids inside thereof, and had an asymmetric structure wherein the pore size gradually increased in the direction from the outer surface to the inner surface. Further, the pore properties of the outer surface of the membrane were controlled efficiently. Whereas, it was confirmed that the membrane of Comparative Example 1 had macrovoids therein whose average diameter was tens of μm, while showing an asymmetric pore structure.

The size of the filter, support and backwash regions of the hollow-fiber membrane prepared in Example 1 and the average diameter of pore thereof were measured using an SEM. As results, the filter region comprising pores having the average diameter of about 0.2 μm was formed in length of about 5 μm in a direction from the outer surface and, in turn, the support region comprising pores having an average diameter of about 1 μm was formed in length of about 200 μm. And then, the backwash region comprising pores having the average diameter of about 2 μm was formed in length of about 50 μm.

### Test Example 2

### Tensile Breaking Strength and Tensile Breaking Elongation Analysis

The tensile breaking strength and elongation of the hollow-fiber membrane prepared in Example 2 were measured by a method described as follows. Specifically, the hollow-fiber membrane prepared in Example 2 was stored in a 50 weight % ethanol aqueous solution for a long period followed by exchanging repeatedly to prepare a wet hollow-fiber membrane. And then, the wet hollow-fiber membrane was fixed to a tensile tester (Zwick 2100) (distance between chuck: about 5 cm). Then, the hollow-fiber membrane was stretched at a tensile rate of about 200 mm/min under the condition of temperature about 25° C. and relative humidity of about 60%. Through this procedure, the tensile breaking strength and tensile breaking elongation were measured respectively by measuring the weight and shift at the point when the test piece (wet hollow-fiber membrane) was fractured.

As a result, the tensile breaking strength of Example 2 was 5.94 MPa, and the tensile breaking elongation was 157%.

### Test Example 3

### Measurement of the Pure Water Permeability

The pure water permeability of the hollow-fiber membrane prepared in Example 3 was measured.

Specifically, 64 hollow-fiber membrane strands having a length of 300 mm were soaked in ethanol followed by soaking in pure water for a long period, and then the ethanol was exchanged for pure water. Then, the hollow fibers exchanged with pure water were soaked in 10 wt % glycerin for several hours followed by drying slowly at a room temperature. After drying, the hollow fibers were fixed to both ends of a PVC tube using an epoxy resin to prepare a small module having the effective area of 0.06 mm². Then, the module was soaked in a 50 wt % ethanol followed by soaking in pure water again to keep the membrane wet. Then, the said module was mounted on an analytical device for a small module which is capable of controlling flow and pressure, and pure water was flowed at 0.5 bar. After 5 mins following the point of its introduction, the permeated amount was measured for 30 mins, and the permeability was calculated according to the below Formula 1.

$$Permeability ( LMH ) = \frac{Permeated amount ( L )}{membrane area ( {m}^{2} ) \times time ( hr )} \qquad [ Formula 1 ]$$

The permeability of the hollow-fiber membrane of Example 3 was measured in the same way as described above. As a result, the membrane had excellent permeability of 173 LMH.

The present invention can provide a fluorine-based hollow-fiber membrane which exhibits a sponge-like pore structure without macrovoids while having an asymmetrical structure. Further, the present invention can provide a fluorine-based hollow-fiber membrane wherein the pore characteristics of the external and internal surfaces are controlled efficiently. Therefore, the present invention can provide a fluorine-based hollow-fiber membrane which has good backwash performance and filter performance while having excellent mechanical strength.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

1. A fluorine-based hollow-fiber membrane which comprises: a filter region which has a sponge-like structure and contains pores having an average diameter of 0.01 μm to 0.5 μm; a support region which has a sponge-like structure and contains pores having an average diameter of 0.5 μm to 5 μm; and a backwash region which has a sponge-like structure and contains pores having an average diameter of 2 μm to 10 μm, wherein the filter region, support region and backwash region are sequentially formed in the direction from the outer surface to the inner surface of the membrane.

2. The fluorine-based hollow-fiber membrane of claim 1, wherein the pores having an average diameter of 0.01 μm to 0.05 μm are formed on the outer surface.

3. The fluorine-based hollow-fiber membrane of claim 1, wherein the pores having an average diameter of 2 μm to 10 μm are formed on the inner surface.

4. The fluorine-based hollow-fiber membrane of claim 1, wherein the tensile breaking strength is more than 4 MPa.

5. The fluorine-based hollow-fiber membrane of claim 1, wherein the tensile breaking elongation is more than 60%.

6. The fluorine-based hollow-fiber membrane of claim 1, wherein the pure water permeability is more than 60 LMH.

7. A production method for the hollow-fiber membrane, which comprises the following steps of:
1) by using a double pipe type nozzle which has an inner pipe and outer pipe, wherein a ratio (L/D) of the nozzle length (L) to the width of the outer pipe (D) is more than 3, discharging an internal bore fluid through the inner pipe of the double pipe type nozzle; and discharging a spinning solution to the outer pipe of the nozzle; and
2) contacting the spinning solution with an external bore fluid.

8. The production method for the hollow-fiber membrane of claim 7, wherein the spinning solution comprises a fluorine-based polymer and appropriate solvent for the fluorine-based polymer.

9. The production method for the hollow-fiber membrane of claim 8, wherein the fluorine-based polymer is poly(vinylidene fluoride) (PVDF).

10. The production method for the hollow-fiber membrane of claim 8, wherein the fluorine-based polymer has the weight average molecular weight of 100,000 to 1,000,000.

11. The production method for the hollow-fiber membrane of claim 8, wherein the appropriate solvent is one or more solvent selected from the group consisting of N-methylpyrrolidone, dimethylformamide, dimethylacetamide, dimethylsulfoxide, methylethylketone, acetone, tetrahydrofuran and polyhydric alcohol.

12. The production method for the hollow-fiber membrane of claim 7, wherein the internal bore fluid comprises water; or a mixed solution of water and organic solvent.

13. The production method for the hollow-fiber membrane of claim 12, wherein the organic solvent is one or more solvent selected from the group consisting of N-methylpyrrolidone, dimethylformamide, dimethylacetamide, dimethylsulfoxide, methylethylketone, acetone, tetrahydrofuran and polyhydric alcohol.

14. The production method for the hollow-fiber membrane of claim 12, wherein the concentration of the organic solvent in the mixed solution is 10 weight % to 90 weight %.

15. The production method for the hollow-fiber membrane of claim 7, wherein the temperature of the internal bore fluid is 10° C. to 30° C.

16. The production method for the hollow-fiber membrane of claim 7, wherein the discharged spinning solution in step 2) contacts with the external bore fluid as soon as the spinning solution is discharged through the double pipe type nozzle.

17. The production method for the hollow-fiber membrane of claim 7, wherein the external bore fluid comprises a non-solvent to the fluorine-based resin; or a mixed solution of the non-solvent and appropriate solvent to the fluorine-based resin.

18. The production method for the hollow-fiber membrane of claim 17, wherein the non-solvent is water.

19. The production method for the hollow-fiber membrane of claim 17, wherein the appropriate solvent is one or more solvent selected from the group consisting of N-methylpyrrolidone, dimethylformamide, dimethylacetamide, dimethylsulfoxide, methylethylketone, acetone, tetrahydrofuran and polyhydric alcohol.

20. The production method for the hollow-fiber membrane of claim 17, wherein the concentration of the appropriate solvent in the mixed solution is 0.5 weight % to 30 weight %.

21. The production method for the hollow-fiber membrane of claim 7, wherein the temperature of the external bore fluid is 40° C. to 80° C.

22. A fluorine-based hollow-fiber membrane, which is produced by the method according to claim 7, and has a tensile breaking strength of more than 4 MPa.
